(19) United States
(12) Patent Application Publication
(10) Pub. No.: US 2026/0052004 A1
(43) Pub. Date: Feb. 19, 2026

(54) QUANTUM BASED SYSTEM AND METHOD OF MULTIPOINT COMMUNICATIONS

(71) Applicant: HEQA SECURITY LTD, Modi'in Maccabim-Re'ut (IL)

(72) Inventors: Nitzan LIVNEH, Mevasseret Zion (IL); Yehuda PILNYAK, Tel-Aviv (IL); Pinhas Yehuda ROSENFELDER, Bet Shemesh (IL)

(21) Appl. No.: 19/103,880

(22) PCT Filed: Sep. 20, 2023
(86) PCT No.: PCT/IL2023/051022

§ 371 Date: Feb. 14, 2025

Related U.S. Application Data
(63) Continuation of application No. 17/948,721, filed on Sep. 20, 2022, now Pat. No. 12,278,885.

(51) Int. Cl. H04L 7/00

(52) U.S. Cl. CPC H04L 7/0079; H04L 7/0075

(57) ABSTRACT

Some embodiments relate to a communication network comprising at least one receiver system optically coupled to a plurality of transmitter systems for transmission of synchronization signals generated by the at least one receiver system to the plurality of transmitter systems over a unidirectional synchronization channel. The at least one receiver system configured to embed into the synchronization signals thereby generated additional data indicative of an internal time count thereof for synchronization of transmission of data/signals from each one of the plurality of transmitter systems to said at least one receiver system over a sparse data/signals unidirectional communication channel.

### CROSS-REFERENCE TO RELATED APPLICATIONS

This application is a national phase filing under 35 C.F. R. § 371 of and claims priority to PCT Patent Application No. PCT/IL2023/051022, filed on Sep. 20, 2023, which claims the priority benefit under 35 U.S. C. § 119 of U.S. patent application Ser. No. 17/948,721, filed on Sep. 20, 2022, the contents of each are hereby incorporated in its entirety by reference.

### TECHNOLOGICAL FIELD

The present application is generally in the field of multipoint communication, and particularly synchronization of point-to-point (P2P), point-to-multipoint (P2MP) and multipoint-to-multipoint (MP2MP) optical communication useful for QKD applications.

### BACKGROUND

This section intends to provide background information concerning the present application, which is not necessarily prior art.

Optical communication networks are designed nowadays for data communication rates of at least 1 Gbps (Gigabit per second). For example, ethernet passive optical networks (EPONs) are designed to provide 1Gbps downstream and 1Gbps upstream communication data rates using 1490 nm and 1310 nm wavelength carrier signals. The synchronization of optical communication between end-nodes operating at such communication data rates is challenging, particularly in quantum key distribution (QKD) applications, wherein the communicated signals are very sparse and noisy, and accurate synchronization is crucial.

In passive optical networks (PONs) passive optical components e.g., fiber-optic lines, AWG splitters, circulators, are used to divide optical signals transmitted from an optical line terminal (OLT e.g., at central office of a service provider) to a plurality of optical network units (ONUs e.g., end-user subscribers, also known as customer premises equipment—CPE), allowing cost-effective provision of broadband services to a large number of end-users. In such PON configurations, the communication of data/signals from the OLT to the ONUs is typically referred to as downstream communication, and the communication of data/signals from the ONUs to the OLT is typically referred to as the upstream communication.

US Patent Publication No. 2016/234018 discloses a quantum communication system, comprising: a plurality of transmitter units, each transmitter unit comprising a source of quantum signals; a receiver unit, comprising: a quantum receiver, comprising at least one detector configured to detect quantum signals; and a first classical communication device; and a passive optical splitter, wherein the plurality of transmitter units are optically coupled to the receiver unit through the passive optical splitter, wherein the passive optical splitter is optically coupled to the quantum receiver through a first spatial channel and optically coupled to the first classical communication device through a second spatial channel, and wherein the passive optical splitter is configured to distribute an inputted optical signal irrespective of its wavelength.

### GENERAL DESCRIPTION

There is a need in the art for P2P, P2MP and MP2MP, optical communication networks usable for QKD implementations, allowing generation of cryptographic keys between at least one receiver system and a plurality of transmitter systems. In a broad aspect there is provided an optical communication network comprising at least one receiver system optically coupled to a plurality of transmitter systems for transmission of synchronization signals generated by the at least one receiver system to the plurality of transmitter systems over a unidirectional synchronization channel, and for transmission of data/signals, which are synchronized by the synchronization signals received over the synchronization channel, from the plurality of transmitter systems to the at least one receiver system over the sparse data (e.g., quantum) communication channel.

In the field of QKD, for example, the terms “transmitter system” and “receiver system” refer to the ability to transmit of receive the sparse quantum-key related communication. In embodiments hereof the transmitter systems and receiver systems can have the ability to transmit and/or receive synchronization signals, and can perform bidirectional data communication. All optical channels can be multiplexed and de-multiplexed (e.g., wavelength division multiplexing—WDM, for example) onto the same optical medium (e.g., optical fiber or free space) or be transmitted on different separate fibers.

In embodiments hereof, additional data is embedded into the synchronization signals generated by the at least one receiver system, for periodically or continuously providing each one of the plurality of transmitter systems a time stamp indicative of an exact time count at the receiver system. In some embodiment the additional data is embedded/encoded into the synchronization signals by flipping a number of bits thereof. In some embodiments, the at least one receiver system is configured to transmit to the plurality of transmitter systems control data over a classical bidirectional (e.g., IP-based data packets) communication channel indictive of time interval(s) in which transmission of the data/signals over the sparse data/signals communication channel is permitted for each one of said plurality of transmitter systems, while it is prohibited for all other transmitter systems.

Optionally, but in some embodiments preferably, the synchronization signal comprises a PRBS (pseudo random bit stream). Each one of the transmitter systems can be accordingly configured to synchronize a local PRBS clock thereof with the synchronization signals receive therein over the synchronization channel, and continuously compare the locally generated PRBS signals with the synchronization signals thereby received over the synchronization channel, in order to detect and extract the additional data embedded therein. The transmitter systems can be further configured to extract the time stamp data embedded/encoded into the synchronization signals and use during the synchronization process of its local PRBS clock.

In possible embodiment, the additional data embedded into the synchronization signals by the at least one receiver system can comprise an identifier of one specific transmitter system from the plurality of transmitter systems, and time-frame data indicative of the time interval(s) in which the transmission of the data/signals over the sparse data/signals (e.g., quantum) communication by the specific transmitter system is permitted.

In one aspect there is provided a communication network comprising at least one receiver system optically coupled to a plurality of transmitter systems for transmission of synchronization signals generated by the at least one receiver system to the plurality of transmitter systems over a unidirectional synchronization channel. The at least one receiver system configured to embed into the synchronization signals thereby generated additional data indicative of an internal time count thereof for synchronization of transmission of data/signals from each one of the plurality of transmitter systems to the at least one receiver system over a sparse data/signals unidirectional communication channel. The communication network can further comprise a bidirectional communication channel configured for classical data exchange between the at least one receiver system and the plurality of transmitter systems, for thereby carrying out QKD key generation procedures between the at least one receiver system and the plurality of transmitter systems based on the data/signals transmitted over the sparse data/signals communication channel.

Optionally, but in some embodiments preferably, the synchronization signal comprises a PRBS. The additional data can comprise a time-tag indicative of a number of PRBS cycles of the synchronization signal. In possible embodiments each one of the plurality of transmitter systems is configured to select based on the additional data embedded in the synchronization signals a portion of the data/signals thereby transmitted over the sparse data/signals unidirectional communication channel for determining a time delay between transmission and reception of the data/signal thereby transmitted over the sparse data/signals unidirectional communication channel. Each one of the plurality of transmitter systems can be configured to determine the delay time based on correlation between the selected portion of the data/signals and a pattern received by the at least one receiver system responsive to the data/signals thereby transmitted over the sparse data/signals unidirectional communication channel. The communication network can be configured to transmit the selected portion of the data/signals to the at least one receiver system for thereby carrying out the correlation and accordingly determining the delay time.

In some embodiments the at least one receiver system is configured to embed the additional data into the synchronization signals by flipping a number of bits thereof. The additional data comprises in possible embodiments an identifier of one of the plurality of transmitter systems and the time-interval(s) during which the transmitter system is permitted to transmit data/signals over the sparse data/signals unidirectional communication channel. The communication network of any one of the preceding claims can be configured to achieve the optical coupling over one or more optical fibers and/or free space, and to realize the different channels therein by respective different wavelengths or wavelength ranges.

The communication network comprises in some embodiments a single receiver system and one or more passive splitters optically coupling between the single receiver system and the plurality of transmitter systems and configured to direct the data/signals transmitted from all of said plurality of transmitter systems over the sparse data/signals unidirectional communication channel for receipt by a single detector of the single receiver system. The communication network can comprise a plurality of receiver systems each of which optically coupled to a respective plurality of transmitter systems by one or more passive splitters and backbone data/signal line configured to realize all of the communication channels between the plurality of receiver systems and the plurality of transmitter systems. The communication network can be configured to assign to each one of the plurality of receiver systems a time-window during which it is permitted to communicate data/signals with all of the transmitter systems in said communication network. The communication network can be configured to assign to each one of the plurality of receiver systems a plurality of non-overlapping sub-time-windows, within its time-window, each one of the plurality of non-overlapping sub-time-windows defining a time-interval during which transmitter systems of the respective plurality of transmitter systems are permitted to communicate data/signals with the receiver system to which said plurality of non-overlapping sub-time-windows are assigned.

The communication network can be configured as a ring network comprising a transmitter interface unit for coupling each one of the plurality of transmitter system to the ring network, and a receiver interfacing unit for coupling each one of the receiver systems to the ring network. Each of the interfacing units can be configured for the transmitter and receiver systems to receive the communication over the communication channels, and transmit data/signal thereover, without interrupting the communication. The interfacing units are configured in possible embodiments to controllably switch direction of signal communication along the ring network. The interfacing units can be configured to controllably block the communication over the ring network at a selected one of the plurality of transmitter systems and permit communication in a determined direction oriented respective to the selected one of the plurality of transmitter system. The communication network can be configured to invert the determined direction of communication therein so as to improve the communication to at least one of the receiver systems. The communication network can be configured to permit all of the receiver system to receive the communication from all of the transmitter systems in the communication network.

In some embodiments each transmitter interface unit comprises two imbalanced couplers configured for respectively coupling the communication to the transmitter system to the ring network from east and west sides thereof. The communication network can comprise a shutter configured to controllably block the communication through the bypass communication line. The communication network can comprise a bypass communication line connecting a pair of output ports of the imbalanced couplers, and a splitter configured to optically couple another pair of output ports of the imbalanced couplers to the transmitter system. The communication network can comprise a west side shutter configured to controllably block west side communication to the splitter, and an east side shutter configured to controllably block east side communication to the splitter.

In some embodiments each receiver interface unit comprises a west circulator configured to receive west side communication from the ring network via a first port thereof, an east circulator configured to receive east side communication from the ring network via a first port thereof, a west splitter optically coupling between to a second port of the west circulator, a third port of the east circulator, and the receiver system and between, and an east splitter optically coupling between to a second port of the east circulator, a third port of the west circulator, and the receiver system and between. The receiver system can comprise a detection unit comprising a west circulator optically coupled to the west splitter via a first port thereof, an east circulator optically coupled to the east splitter via a first port thereof, an imbalanced interferometer optically coupled second ports of the circulators via its inputs ports, two detectors respectively optically coupled to third ports of the circulators, and two mirrors respectively coupled to output ports of the imbalanced interferometer.

The at least one of the receiver systems is configured in some embodiments to measure the data/signals transmitted over the sparse data/signals unidirectional communication channel and based thereon transmit instructions to at least one of the transmitter systems to adjust a wavelength of its transmissions over said sparse data/signals unidirectional communication channel. Optionally, the communication network configured to determine length and/or changes therein based at least on one of a back-to-back and round-trip delay times.

### BRIEF DESCRIPTION OF THE DRAWINGS

In order to understand the presently disclosed subject matter and to see how it may be carried out in practice, embodiments will now be described, by way of non-limiting example only, with reference to the accompanying drawings. Features shown in the drawings are meant to be illustrative of only some embodiments of the presently disclosed subject matter, unless otherwise implicitly indicated. In the drawings like reference numerals are used to indicate corresponding parts, and in which:

FIG. 1 is a block diagram schematically illustrating a point-to-point (P2P) communication system according to possible embodiments;

FIGS. 2A to 2E are block diagrams schematically illustrating configurations of P2MP communication systems useful according to possible embodiments for QKD implementations, wherein FIG. 2A depicts general connectivity in a P2MP communication system implementations, FIG. 2B demonstrates channel management in the P2MP communication system, FIG. 2C demonstrates a PON P2MP communication system implementation, and FIGS. 2D and 2E demonstrate channel management in the PON P2MP communication system;

FIG. 3 demonstrates a MP2MP communication system according to possible embodiments;

FIGS. 4A to 4D schematically illustrate a ring PON configuration according to possible embodiments, wherein FIG. 4A shows a possible ring PON, FIG. 4B shows a possible transmitter interface to the ring PON, FIG. 4C shows a possible receiver interface to the ring PON, and FIG. 4D shows a possible detection setup of receivers in the ring PON; and

FIG. 5 schematically illustrates a MP2MP communication network according to some possible embodiments.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Emphasis instead being placed upon clearly illustrating the principles of the presently disclosed subject matter such that persons skilled in the art will be able to make and use the optical communication techniques, once they understand the principles of the subject matter disclosed herein. This presently disclosed subject matter may be provided in other specific forms and embodiments without departing from the essential characteristics described herein.

The present application provides P2P, P2MP and MP2MP, optical communication network configurations optimized for QKD implementations. In embodiments disclosed herein receiver system(s) are configured to transmit synchronization signals to a plurality of transmitter systems over a synchronization channel, for synchronizing transmission of data/signals from the plurality of transmitter systems over a sparse data (e.g., single photon quantum) communication channel to the receiver system(s).

Optionally, but in some embodiments preferably, additional data is embedded/encoded by the receiver system(s) into the synchronization signals for optimizing synchronization procedures between the receiver system(s) and the plurality of transmitter systems. For example, the additional data can comprise timing information configured for efficient synchronization between the receiver system(s) and the plurality of transmitter systems. Optionally, the additional data comprises control data configured for assigning to each of the plurality of transmitter systems a time interval in which it is permitted to transmit its (e.g., quantum) data/signals over the sparse data communication channel.

In some embodiments a bidirectional communication channel is also provided between the receiver system(s) and the plurality of transmitter systems for classical (e.g., data packets) data communication therebetween. The sparse data communication channel, the synchronization channel, and the bidirectional communication channel, can all be realized over one or more optical fibers and/or free space, by assigning a respective wavelength, or wavelength range, to each communication channel.

The optical network configurations disclosed herein can be adapted to implement P2P, P2MP and/or PM2PM, PON networks, allowing carrying QKD key generation procedures between multiple transmitter and receiver systems thereof. In some applications the optical network configurations disclosed herein are adapted to implement ring network topologies configured for simplex or duplex connectivity. In possible applications the ring network topologies are configured to controllably switch the direction of the signal communication along the ring. Such applications can be adapted to controllably (e.g., periodically intermittently or per system requirements) block the signal communication at a selected transmitter (or receiver) system along the ring in order to optimize data/signal communication along portion(s) of the ring and/or prevent reception of the same data/signals multiple times by the same receiver system(s).

For an overview of several example features, process stages, and principles of the presently disclosed subject matter, the data communication examples illustrated schematically and diagrammatically in the figures are intended for QKD applications. These QKD applications are shown as one example implementation that demonstrates a number of features, processes, and principles used to provide reliable and secure QKD key generation, but they are also useful for other applications and can be made in different variations. Therefore, this description will proceed with reference to the shown examples, but with the understanding that the presently disclosed subject matter recited in the claims below can also be implemented in myriad other ways, once the principles are understood from the descriptions, explanations, and drawings herein. All such variations, as well as any other modifications apparent to one of ordinary skill in the art and useful in optical communication networks applications may be suitably employed, and are intended to fall within the scope of this application.

FIG. 1 schematically illustrates a P2P communication system 10 according to possible embodiments, comprising a transmitter system (Tx) 11 and a receiver system (Rx) 12 configured to communicate data/signals over at least first and second unidirectional data communication channels C1 and C2. In some embodiments the unidirectional communication channel C1 is used for transmittal of sparse quantum data/qubits from the transmitter 11 to the receiver system 12 (e.g., single-photon communication over an optical fiber or free space), and the unidirectional communication channel C2 is used for transmittal of synchronization signals from the receiver 12 to the transmitter 11 (e.g., over optical fiber, electrical cables, or wirelessly such as free-space-optics—FSO, or electromagnetic radio frequency waves—RF).

Optionally, but in some embodiments preferably, a third communication channel C3 is used for bidirectional (e.g., data packets) communication to exchange data between the transmitter 11 and the receiver 12 systems (e.g., over optical fiber, electrical cables, or wirelessly such as free-space-optics—FSO, or electromagnet radio frequencies—RF).

In some embodiments the unidirectional communication channel C1 is used as a quantum data line for transmittal of streams of sparse quantum data signals (e.g., single-photon quantum communication), and the communication channel C2 is used as a synchronization line for transmittal of serial synchronization signals (e.g., clock signals). The synchronization signal generator 14 of the receiver system 12 is configured to generate serial synchronization signals S_{sync} utilizing internal clock 12k transmitted to the transmitter system 11 over the unidirectional communication channel C2 for synchronizing the sparse serial data communication thereby transmitted over the unidirectional communication channel C1. Optionally, but in some embodiments preferably, the serial synchronization signals produced by the synchronization signal generator 14 comprises a PRBS generated by the internal clock 12k.

The transmitter system 11 comprises a serial data/signal transmitter (DTx e.g., a single photon quantum transmitter) 11t configured to transmit serial data/signals over the unidirectional communication channel C1, and a timing unit 11f configured to receive the synchronization signals S_{sync} from the transmitter system 12 over the unidirectional communication channel C2, and based thereon synchronize an internal clock 11k thereof and/or trigger transmission of the serial data/signal streams by the data transmitter 11t over the unidirectional communication channel C1. One or more processors 11p and memories 11m can be used to execute program code configured to orchestrate the operation of the various components of the transmitter system 11. A classical data communication (e.g., internet protocol—IP) module 11x can be used in the transmitter system 11 to manage the bidirectional data exchange with the receiver system 12 over the third communication channel C3.

The transmitter system 11 further comprises a transceiver 16 having the functionality of the transceiver 16 of the receiver system 12, configured to use its CDR to guarantee that the transmitter system and the receiver system are operating with the exact same clock frequency, and to prevent signal driftS between the transmitter system 11 and loss of synchronization with the receiver system 12.

The receiver system 12 comprises a serial data/signal receiver (DRx e.g., a serial single photon receiver) 12r configured to receive the serial (e.g., quantum) data/signal streams transmitted over the unidirectional communication channel C1 and generate corresponding electric signals S_{dat} therefor. The data/signal receiver 12r can utilize optoelectronic measuring instrument, such as a single photon detector (e.g., avalanche photodiode), to convert single-photon (e.g., qubits) signals transmitted over the unidirectional communication channel C1 into corresponding electric signals S_{dat}. In QKD implementations the receiver system 12 is required to determine the accurate transmittal timings of the serial data/signal streams over the unidirectional communication channel C1, which in embodiments hereof synchronized at the transmitter system 11 by the synchronization signals S_{sync} thereby received over the unidirectional communication channel C2.

The receiver system 12 further comprises a mixer unit 15 configured to mix the received serial data/signal streams S_{dat} with the synchronization signals S_{sync} from the synchronization signal generator 14. The receiver system 12 can further include a transceiver unit 16 configured to convert the mixed serial signal streams Sₘᵢₓ from the mixer 15 into parallel mixed signal streams Pₘᵢₓ, and demix the parallel signal streams Pₘᵢₓ to thereby obtain a parallel data stream P_{dat} of the data/signals received over the unidirectional communication channel C1. One or more processors 12p and memories 12m can be used to execute program code configured to orchestrate the operation of the various components of the receiver system 12. A classical data communication (e.g., internet protocol—IP) module 12x can be used in the receiver system 12 to manage the bidirectional data exchange with the receiver system 11 over the third communication channel C3.

In some embodiments the unidirectional communication channels C1 and/or C2 are both optical channels, and the timing unit 11f of the transmitter system 11, and the serial data/signal receiver 12r of the receiver system 12, are configured to convert the optical signals received over these unidirectional channels into corresponding electrical signals. For example, but without being limiting, the unidirectional communication channel C2 can be implemented by one or more optical fibers, and the synchronization signals transmitted thereover can be converted at the timing unit 11f from optical to electrical signals S_{sync} e.g., by a small form-factor pluggable (SFP) module (not shown). The synchronization signals S_{sync} can comprise a known, balanced periodic digital clock signal, such as 01010101 . . . (period of 2), or a PRBS having longer period e.g., generated utilizing a predefined monic polynomial and seed value. Optionally, but is some embodiments preferably, all of the communication channels C1,C2,C3 are implemented as different optical channels spectrally divided in the same optical communication medium e.g., optical fiber or free space (e.g., using wavelength-division multiplexing—WDM). The mixer unit 15 can be implemented by a fast serial exclusive OR (XOR) logical gate capable of operating at data rates of at least the data rate of the synchronization channel C2 e.g., 1Gbps or 10Gbps, such as Analog Device's HMC745 XOR/XNOR gate designed to support up to 13 Gbps data rates.

A tuneable time delay unit (TD) 12t can be used to controllably (e.g., based on control signals from the processor 12p) set a time delay between the serial data/signal streams S_{dat} from the data/signal receiver 12r and the synchronization signals S_{sync} from the synchronization signal generator 14, so as to align the serial data/signal streams S_{dat} and synchronization signals S_{sync} in time for accurate bit signals overlap. If the tuneable time delay unit 12t is not used, the signal from the synchronization signal generator 14 can be directly supplied to the mixer 15.

This way, the sparsity of the electric data/signals S_{dat} generated by the data/signal receiver 12r is substantially reduced, such that the redundancy of the mixed signal Sₘᵢₓ generated by the mixer 15 is suitable for use with a conventional transceiver unit (e.g., Intel (Altera) FPGAs, such as Cyclone10, Arria10, or Stratix10) 16 to exploit their deserializing (SERDES 16r) and clock data recovery (CDR 16c) capabilities to handle the quantum data communication.

The mixed signal Sₘᵢₓ produced by the mixer 15 is fed into the transceiver device 16, for signal timing/synchronization and processing. The frequency Fₘᵢₓ of the mixed signal Sₘᵢₓ is recovered by the CDR circuitry 16c of the transceiver 16, which is used by the synchronization signal emulator 16e to generate lower rate parallel (deserialized) E_{sync} for components of the transceiver unit 16. The mixed signal Sₘᵢₓ produced by the mixer 15 is simultaneously deserialized by the SERDES circuitry 16r of the transceiver device 16, which generates a lower rate parallel (deserialized) mixed signal stream Pₘᵢₓ.

An internal parallel demixing (e.g., logical XOR gate circuit) 16x of the transceiver device 16 can be used to demix the lower rate parallel (deserialized) mixed signals stream Pₘᵢₓ with the lower rate parallel (deserialized) synchronization signals E_{sync}, and thereby remove the redundancy introduced into the serial data signal stream S_{dat} by the serial mixer 15. A time frame tuning module (Tx-Rx time difference tuning) 19 is used in possible embodiments to accurately register the lower rate parallel data stream P_{dat} produced by the internal parallel logical XOR gate circuit 16x with respect to the synchronization signals S_{sync} from the synchronization signal generator 14, by correlating at least a portion of the lower rate parallel data signals stream P_{dat} with the predefined/known data pattern Cₚₐₜₜₑᵣₙ.

The timing data determined by the time frame tuning module 19 can be used to determine the exact time delay (i.e., between the transmittal and receipt of the data/signals over the unidirectional communication channel C1) between the transmitter 11 and receiver 12 system, which is essential in QKD implementations. For example, in possible embodiments data for post-process correlation Cₚₐₜₜₑᵣₙ and/or error estimation i.e., this data is not essentially pre-determined and known to the receiver system 12, is transmitted to the receiver system 12 over the bidirectional communication channel C3.

In order to accurately determined time delay between the transmitter 11 and receiver 12 system, the post-process correlation data Cₚₐₜₜₑᵣₙ comprises in embodiments hereof at least a portion of the data/signals transmitted by to the receiver system 12 over the unidirectional communication channel C1 e.g., during system calibration process. In some embodiments the post-process correlation data Cₚₐₜₜₑᵣₙ is transmitted to the receiver system 12 over the bidirectional communication channel C3. Optionally, the timing data determined by the time frame tuning module 19 is used to set the delay time affected by the tuneable time delay unit 12t.

Optionally, but in some embodiments preferably, the time frame tuning 19 calibration process is carried out at the transmitter system 11. In such embodiments the accurate time delay between the transmitter 11 and the receiver 12 system is thus determined at the transmitter system 11, and can be shared with the receiver system 12 over the bidirectional communication channel C3 for achieving correlation between the transmission of receipt of the data/signals over the unidirectional communication channel C1. For example, during a system calibration process the receiver system 12 can send to the transmitter system 11 post-process correlation data (Cₚₐₜₜₑᵣₙ′) indicative of at least a portion of the data/signals received by its data/signal receiver 12r, for correlating with the data/signals actually transmitted by the data/signals transmitter 11t of the transmitter system 11 and accurately determining the time delay between the transmitter 11 and receiver 12 systems.

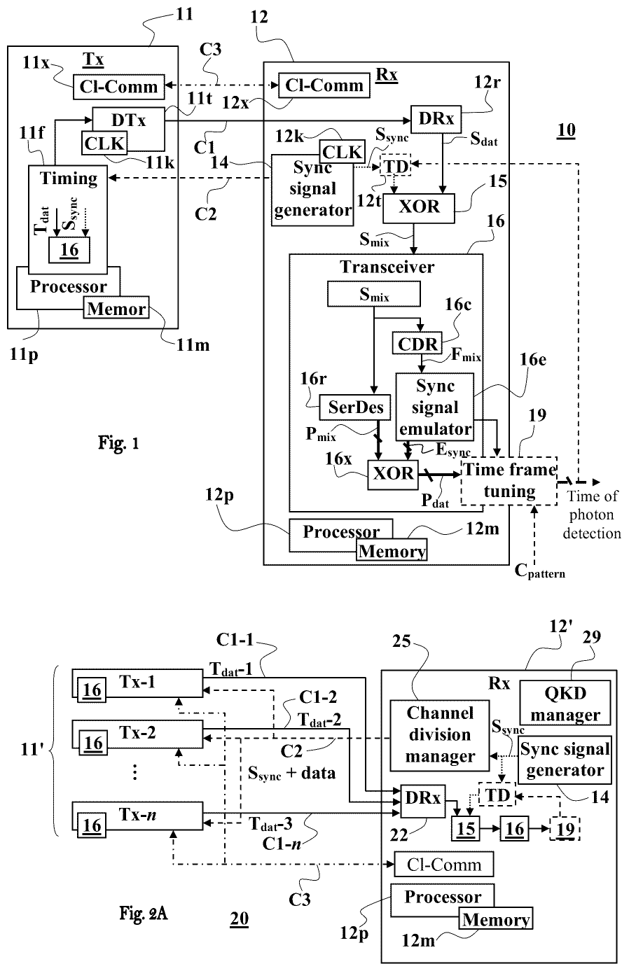

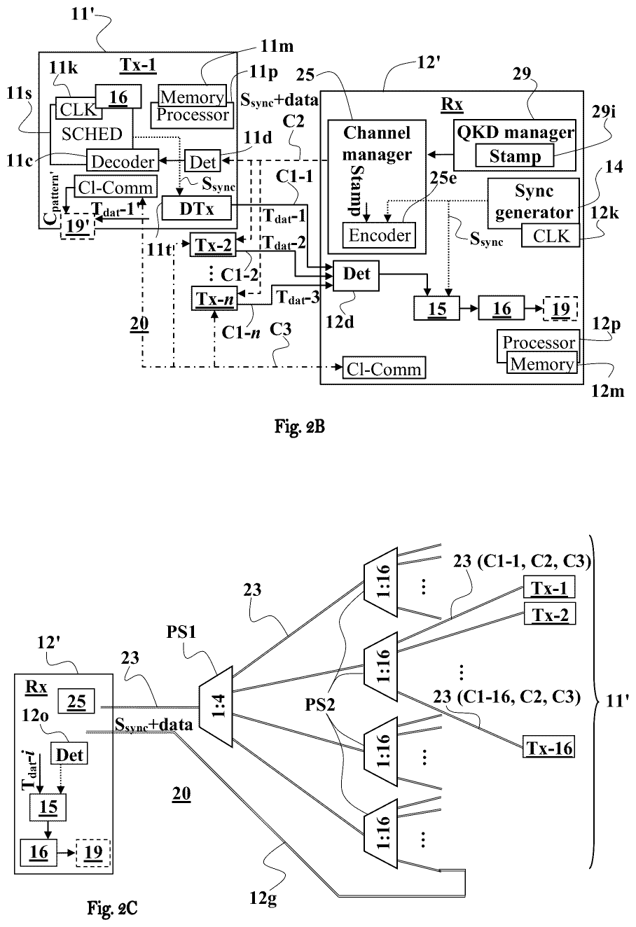

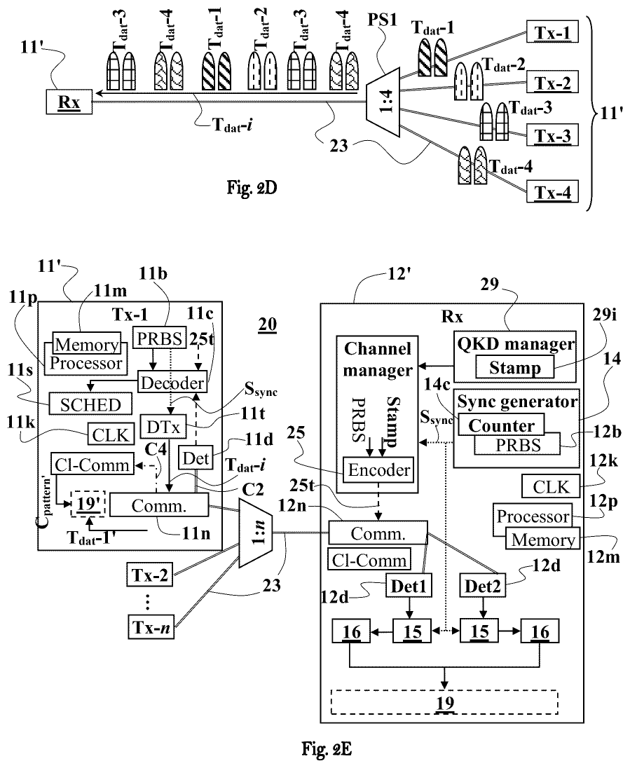

FIG. 2A is a block diagram schematically illustrating a communication system 20 according to possible embodiments, wherein the synchronization signals S_{sync} generated by the synchronization signal generator 14 at the receiver system 12′ are transmitted from the receiver system to a plurality of transmitter systems 11′ (Tx-1, Tx-2, . . . , Tx-n, collectively referred to herein as transmitter systems Tx-i where i,n>1 are an integers) over the synchronization channel C2. This way, a single receiver system 12′can be used to synchronize transmissions of a plurality sparse data/signals communications T_{dat}-1, T_{dat}-2, . . . , T_{dat}-n received from a respective plurality of transmitter systems Tx-1, Tx-2, . . . , Tx-n over a respective plurality of sparse data communication channels C1-1, C1-2, . . . , C1-n.

Optionally, but in some embodiments preferably, the receiver system 12′is configured to transmit additional data to the transmitter systems Tx-i over the synchronization channel C2, together with the synchronization signals S_{sync}. The channel division manager unit 25 is configured in some embodiments to encode in the additional data transmitted over the synchronization channel C7 timing information for managing the operation of the plurality of the transmitters Tx-1, Tx-2, . . . , Tx-n. Optionally, but in some embodiments preferably, the channel division manager unit 25 is configured and operable to encode/embed in the additional data transmitted over the synchronization channel C2 timing information (e.g., a time stamp for accurate synchronization) configured for scheduling the transmission of the sparse data signals T_{dat}-1, T_{dat}-2, . . . , T_{dat}-n by each one of the plurality of the transmitters Tx-1, Tx-2, . . . , Tx-n to the receiver 12′ e.g., using time division multiplexing and/or round robin techniques.

Accordingly, in this configuration the receiver system 12′ can synchronize the plurality of transmitter systems Tx-1, Tx-2, . . . , Tx-n to the same communication frequency of the system 20 by the synchronization signals S_{sync} transmitted over the synchronization channel C2, and also to schedule the sparse data signals/communications T_{dat}-1, T_{dat}-2, . . . , T_{dat}-n transmitted by each one of the plurality of the transmitter systems Tx-1, Tx-2, . . . , Tx-n by means of the additional data also transmitted over the synchronization channel C2. Time division multiplexing (TDM) techniques can be used in the receiver system 12′to synchronize (e.g., over the bidirectional communication channel C3) and receive the plurality of sparse data signals/communications T_{dat}-1, T_{dat}-2, . . . , T_{dat}-n utilizing different optical channel defined in the same optical medium (e.g., an optical fiber and/or free space) and a single serial data/signal receiver (DRx) 22 (e.g., comprising one, two or four, single photon detectors).

Optionally, but in some embodiments preferably, the channel division manager unit 25 is configured to repeatedly/periodically use a certain synchronization bit sequence of the synchronization signals S_{sync}, and encode/embed the additional data (e.g., timing synchronization information) thereinto e.g., by flipping (i.e., inverting) one or more of the bits of the synchronization bits signals S_{sync}. The plurality of the transmitter systems Tx-1, Tx-2, . . . , Tx-n can accordingly use encoder (e.g., logical XOR gates) to detect the information encoded/embedded by the channel division manager unit 25 in the synchronization signals S_{sync} (assuming a predefined/known synchronization sequence is used).

The receiver system 12′comprises in some embodiments a QKD manager unit 29 configured to manage QKD procedures between the receiver system 12′and each one of the plurality of transmitter systems Tx-i. This way, the receiver system 12′can manage generation of QKD encryption keys with a plurality transmitter systems Tx-i over a single synchronization channel C2 and utilizing a single data/signal detector at the receiver system 12′.

The synchronization signals channel C2 is configured in some embodiments to implement a dense wavelength division multiplexing (DWDM) channel, which normally transmits no data in the direction opposite to the direction of synchronization signals transmission. Sending the data in the direction of synchronization signals over the synchronization channel C2 may require more effort. The data can be sent over the synchronization channel C2 by flipping bits of the synchronization signals S_{sync} (e.g., by XORing the data with bits of the synchronization PRBS signals before serializing the synchronization signals and transmitting them). It is noted that sending data over the synchronization channel C2 has the advantage of minimal latency, unlike a classical IP communication channel e.g., C3.

FIG. 2B demonstrates channel management in a P2MP communication system 20 according to possible embodiments. As seen, in some embodiments the QKD manager 29 is configured to generate the additional data 29i to be encoded by the Channel manger 25 into the synchronization signals S_{sync} generated by the synchronization signal generator 14. In this non-limiting example the additional data 29i comprises a time-Stamp indicative of the exact time count of the clock 12k of the receiver system 12′when the synchronization signals are being sent to the plurality of transmitter systems 11′over the synchronization channel C2. The QKD manager 29 can be configured to define non-overlapping TDM transmission time-frames (TF-1, TF-1, . . . , TF-n) to the plurality of transmitter systems 11′, which can be transmitted to the transmitter systems 11′over the bidirectional communication channel C3. Any suitable known ordering algorithm can be used to determine the TDM time-frames and their order, but it can be simply implemented by activating a single transmitter system 11′for transmission with each time-frame in a “round robin” form, and optionally delaying the transmission by a few bits to ensure orderly transmission of the sparse data/signals T_{dat}-i.

Each of the plurality of transmitter systems Tx-i comprises respective detector (e.g., small form-factor pluggable-SFP module) 11d for converting the signals received over the synchronization channel C2 into corresponding electrical signals, and a decoder (e.g., XOR gate circuitry) 11c configured to extract/decode the time-stamp data (Stamp) from the electrical signals generated by the detector 11d. A scheduler unit (SCHED) 11s can be configured in each transmitter system Tx-i to process the data/signals extracted by its decoder 11c, and determine based thereon the exact time count of the clock 12k of the receiver system 12′during the transmission of the synchronizing signals over the synchronization channel C2.

The scheduler unit 11s can be further configured to activate the data/signals transmitter 11t to transmit the sparse data signals/communications T_{dat}-i of the transmitter Tx-i within the time-frame (TF) specified therefor by the QKD manger unit 29 of the receiver 12. After extracting the additional data (Stamp) from the data/signals generated by the detector 11d, the scheduler unit 11s can recover the original synchronization signals (i.e., without the additional time-samp data) S_{sync} generated by the synchronization signal generator 14 of the receiver system 12′, and provide the same to the data transmitter 11t to synchronize the sparse data/signals thereby transmitted.

This way, a single detector (e.g., single photon detector) 12d can be used at the receiver system 12′to receive all sparse data/signals T_{dat}-i transmitted thereto by the plurality of transmitter systems 11′over the same unidirectional communication channel C1 using the same optical medium and optical channel/wavelength. However, in possible embodiments at least two detectors 12d are used in order to receive the sparse data/signals transmitted to the receiver system 12′over unidirectional communication channel C1, wherein each detector 12d is configured to detect a certain quantum state (qubit) of a quantum communication. In yet other possible embodiments, at least four detectors 12d are used at the receiver system 12′, wherein each detector 12d is configured to detect a certain quantum state (qubit) of a quantum communication.

As seen, each transmitter system 11′comprises the transceiver 16 configured to synchronize the clock frequency of the of the transmitter system 11′to the clock frequency of the transmitter system, as described hereinabove.

FIG. 2B further exemplifies use of time frame tuning 19′at the plurality of transmitter systems 11′. The time frame tuning 19′is configured to determine the exact time delay between its transmitter system Tx-1 and the receiver system 12′by correlating at least some portion of the data/signals T_{dat}-1′thereby transmitted over the unidirectional communication channel C1 with post-process correlation Cₚₐₜₜₑᵣₙ′ data indicative of the data/signals received at the receiver system 12′due to the transmission of the data/signals T_{dat}-1′over the unidirectional communication channel C1. In some embodiment the receiver system 12′is configured to send respective post-process correlation Cₚₐₜₜₑᵣₙ′ data to each one of the transmitter systems Tx-i over the bidirectional communication channel C3. The time delay between the transmitter and receiver systems is then shared between the transmitter and receiver whether it was extracted on the transmitter system side or on the receiver system side.

FIG. 2C schematically illustrates a PON implementation of the communication system 20 utilizing one or more passive splitters PS1, PS2, . . . and optical fibers 23 arranged to form a star P2MP configuration for implementing the communication channels C1, C2 and C3 between the receiver system 12′and a plurality of transmitter systems 11′. In this exemplary configuration the communication channels C1, C2 and C3, are realized by optical signals of respective different wavelengths λ1, λ2 and λ3 (i.e., optical channels), simultaneously passed along the same optical medium branches (e.g., optical fiber and/or free space) of the PON. Some of the advantages of this PON configuration are due to the reduction in the number of hardware units its requires, which consequently results in reduced construction, operation and maintenance cost, reduced complexity, and enhanced security, as less trusted nodes are required and more key generation paths can be used.

The central receiver system 12′is configured, as explained hereinabove, to provide the plurality of transmitter systems 11′with time-stamps for performing the signal correlation required to extract the precise time delay between the receiver and each of the transmitters feasible. Without having a low latency channel for time stamp sharing the correlation process requires high compute and memory capabilities for the transmitter, as the transmitted data rate can surpass 1 Gbps, and the timing uncertainty can be in the order of 1 second. Having a small time uncertainty saves cost, system complexity and improves the link up-time. Having the same operation frequency and accurate delay time between the transmitter system and the receiver system improves the accuracy of the sparse (e.g., quantum) data communication over the unidirectional communication channel C1 e.g., by TDM (time domain multiplexing). As exemplified in FIG. 2D, this way overlap between the sparse data/signals (T_{dat}-i) from the transmitter systems 11′is prevented, and the receiver system 12′is capable of recognizing at any given time which of the transmitter systems 11′transmitted the sparse data/signals (T_{dat}-i) thereto. Accordingly, in such PON configuration, all of the transmitter systems 11′transmit their (e.g., quantum) data/signals to the receiver system 12′upstream, over the unidirectional communication channel C1, with the same wavelength. A second wavelength can be similarly assigned for the unidirectional synchronization channel C2, and a third wavelength, can be similarly assigned for the bidirectional communication channel C3.

FIG. 2C also exemplifies a possible embodiment wherein the synchronization signals S_{sync} downstream transmitted by the receiver system 12′with the embedded additional data (time-Stamp) over the synchronization channel C2 are sent back to the receiver system 12′ either by direct fiber connection (loop-back) or from one of the downstream splitters (PS2) over an auxiliary optical medium line (e.g., optical fiber and/or free space) 12g, and mixed by the mixer 15 with the at least some portion of the sparse data/signals T_{dat}-i received over the unidirectional communication channel C1. Though this implementation requires an additional (e.g., a form-factor pluggable—SFP) detector 120 at the receiver 12′and auxiliary optical medium 12g, in possible embodiments it may be exploited to enable the receiver system 12′to accurately determine the time delay introduced by the PON, and thereby simplify the determining of the exact time delay between the receiver system 12′and each one of the plurality of transmitter systems 11′.

FIG. 2E shows a possible embodiment of the PON communication system 20 implemented with a PRBS clock 12b used in the synchronization signal generator 14 of the receiver 12′as the synchronization signal S_{sync}. The additional data (Stamp) is embedded/encoded in this example into the PRBS synchronization signal S_{sync} by the encoder (e.g., XOR gate). In some embodiments the additional data (Stamp) is embedded into the PRBS synchronization signal S_{sync} by flipping some of its bits, consecutively, or of a certain bit location in a sequence of consecutive bytes/words of the PRBS. The PRBS synchronization signal S_{sync} with the additional data (Stamp) embedded/encoded thereinto 25t is transmitted over the PON by an optical communication unit 12n of the receiver 12′.

Communication units 11n of the transmitter systems 11′receives the PON communication and splits the synchronization channel C2 to the detector 11d, which recovers therefrom the PRBS synchronization signal S_{sync} with the additional data (Stamp) embedded thereinto 25t. The decoders 11c (e.g., XOR gate) of the receiver systems 11′utilize in some embodiments an internal PRBS clock 11b synchronized with PRBS clock 12b of the receiver system 12′, to detect and extract the additional data (Stamp) embedded in the PRBS synchronization signal S_{sync}. The scheduler units 11s of the transmitter systems 11′can receive the extracted additional data (Stamp) and use it to timely activate their data transmitters 11t to transmit the sparse data signals/communications T_{dat}-i of the transmitter systems 11′within the time-frame (TF) specified therefor. The data transmitters 11t can be configured to receive the PRBS synchronization signal S_{sync} from the decoder 11c, or alternatively from the internal PRBS clock 11b of the receivers 11′, to synchronize the transmission of the sparse data signals/communications T_{dat}-i with the transmitter 12′.

In this non-limiting example the receiver system 12′utilizes two detectors (e.g., Det1,Det2 each configured to detect a certain qubit state) 12d to receive the sparse data signals/communications T_{dat}-i transmitted thereto over the unidirectional communication channel C1. A pair of mixers 15 can be used to mix the signals from the respective detectors 12d with the PRBS synchronization signal S_{sync} from the synchronization signal generator 14. The mixed signals from the two mixers 15 can be processed by a respective pair of transceiver units 16, wherefrom the demixed deserialized data is combined and optionally fed to the time frame tuning module 19.

If the time frame tuning 19′is carried out at the transmitter system 11′, the time-stamp data 19i extracted/decoded by the decoder 11c can be used by the transmitter system 11′to determine the time of receipt of the sparse data signals/communications T_{dat}-1 at the receiver 12′with significantly increased accuracy. This way, the transmitter system 11′can reliably identify at least some portion T_{dat}-1′of the sparse data signals/communications T_{dat}-1 received at the receiver system 12′for the correlation with the post-process correlation Cₚₐₜₜₑᵣₙ′, and thereby substantially reduce the time and processing efforts required to precisely determine the time delay of transmission over the unidirectional communication channel C1, as required for carrying QKD procedures. Optionally, but in some embodiments preferably, the time-stamp data 29i is generated by an internal counter 14c of the synchronization signal generator 14 configured to count cycles of the PRBS clock 12b.

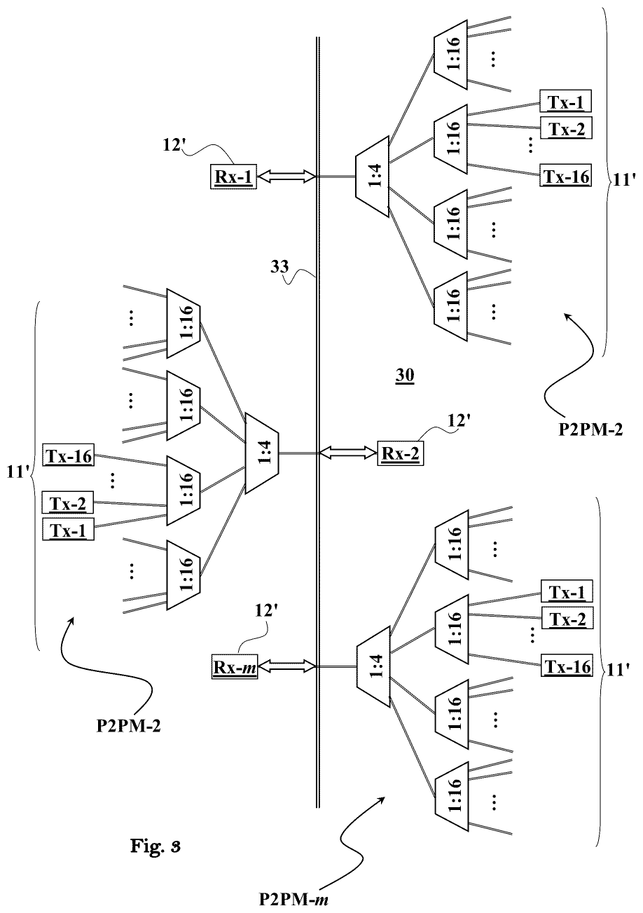

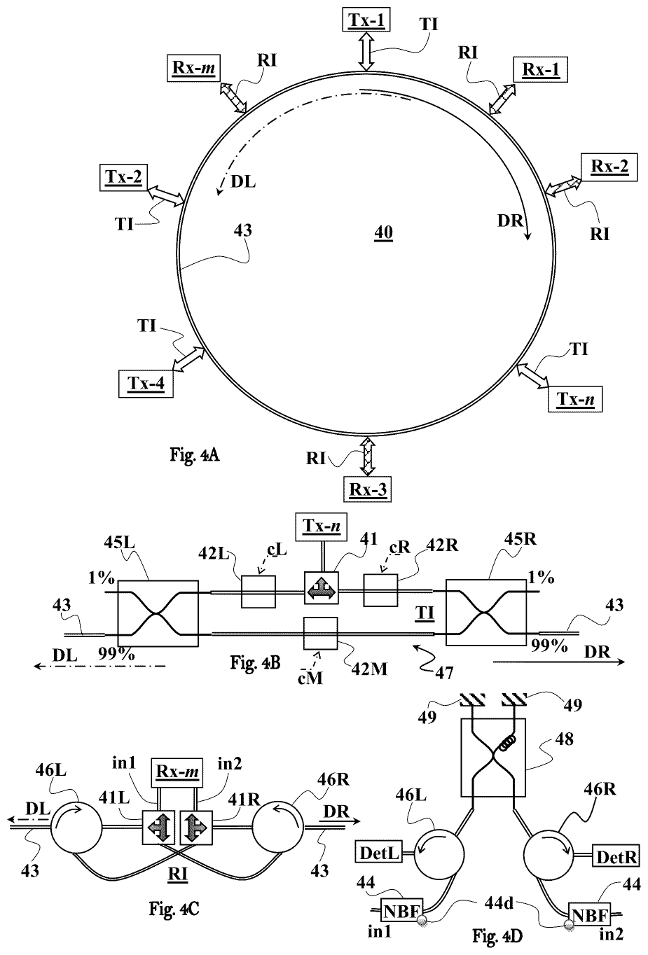

FIG. 3 schematically illustrates a MP2MP PON communication system 30, comprising a plurality of P2MP PON systems P2PM-1, P2PM-2, . . . , P2PM-m (where m>1 is an integer), each configured as a P2MP PON system 22 of any one of FIGS. 2A to 2E. The downstream and upstream communication between the receiver systems Rx-1, Rx-2, . . . , Rx-m, and the ONUs of their P2MP PON systems P2PM-1, P2PM-2, . . . , P2PM-m, is passed through a main/backbone optical fiber line 33, such that each end-node in the MP2MP PON communication system 30 can receive the downstream and upstream communication of each of the P2MP PON systems P2PM-1, P2PM-2, . . . , P2PM-m. Optionally, the main/backbone optical fiber line 33 implements a ring topology such as illustrated in FIG. 4A, or short optical fibers in a telecom central office (CO) serving several PON networks.

Accordingly, in QKD implementations, each one of the receiver systems Rx-1, Rx-2, . . . , Rx-m, can communicate quantum signals with any one of the transmitter systems Tx-1, Tx-2, . . . of any one of the P2MP PON systems P2PM-1, P2PM-2, . . . , P2PM-m e.g., Rx-2 can receive quantum data/signals over the unidirectional communication channel C1 from Tx-2 of the P2PM-1 PON system. In possible embodiments a time division, or a simple round robin, scheme is utilized to determine a time-window for each one of the receiver systems Rx-1, Rx-2, . . . , Rx-m, to communicate with the transmitter systems Tx-1, Tx-2, . . . of the P2PM-1, P2PM-2, . . . , P2PM-m PON systems, and a set sub-time-windows within each time-window for the respective receiver Rx-j (where j>0 is an integer) to communicate with the transmitter systems Tx-1, Tx-2, . . . of one of the P2PM-1, P2PM-2, . . . , P2PM-m PON systems.

This way, each receiver systems Rx-1, Rx-2, . . . , Rx-m, can manage its transmitter systems Tx-1, Tx-2, . . . e.g., set their bit delays such that their transmitted sparse data/signals (T_{dat}-i) don't overlap, so as to obtain an ordered train of sparse data/signals (T_{dat}-i) received from its main passive splitter (PS1), as demonstrated in FIG. 2D. In such embodiments, in each time-window the specific receiver system Rx-j authorized as master of all other receiver systems, can be configured to synchronize the data/signal pulse trains (T_{dat}-i) transmitted over the different P2PM-1, P2PM-2, . . . , P2PM-m branches e.g., by determining a sub-time-window for each P2PM-1, P2PM-2, . . . , P2PM-m which can be transmitted to the transmitter systems (11′) over the bidirectional communication channel (C3).

Accordingly, in QKD implementations, since the main backbone optical fiber 33 conveys all of the quantum communication pulse trains (T_{dat}-i) of all of the P2PM-1, P2PM-2, . . . , P2PM-m systems to all of the receiver systems, each one of the receiver systems Rx-j can generate an independent encryption key with any one of the transmitter systems Tx-j in any one of the P2PM-1, P2PM-2, . . . , P2PM-m systems. This way, the total security of the network is increased, while the hardware resources required for the implementation are significantly reduced.

FIG. 4A schematically illustrates a ring MP2MP network topology 40, wherein multiple transmitter systems Tx-1, Tx-2, . . . , Tx-n, and multiple receiver systems Rx-1, Rx-2, . . . , Rx-m, are optically coupled over a ring-shaped/looped main/backbone optical fiber 43. The communication over the main/backbone optical fiber 43 can use either simplex or duplex connectivity, and configured such that one unit on the ring network system, either a transmitter system Rx-j or receiver system Tx-i (generally referred to as end-nodes), transmits the synchronization signals (S_{sync} ) to all other transmitter and receiver systems. Thus, all of the other transmitter and receiver systems (i.e., that don't transmit the synchronization signals) either “tap”the synchronization signals or receives and re-transmits them.

More particularly, in possible embodiments each one of the transmitter and receiver end-node systems in the ring network 40 can be configured for active or passive receipt of the synchronization signals (S_{sync} ). In the passive signal receive state the end-node taps to the synchronization channel to measure the synchronization signals, thereby attenuating (e.g., 10%-20%) the synchronization signals. Thus, continuous passive receipt of the synchronization signals along the ring network 40 can significantly reduce the signals'power and damage communication with end-nodes located remote to the synchronization signals' source. Thus, some of the end-nodes are configured for active receipt of the synchronization signals, which means cutting the continuous signal propagation at the actively receiving end-node and directing it into the synchronization signals' detector for measurement, and simultaneously transmitting an amplified, regenerated copy of the signals measured by the synchronization signals'detector towards the other downstream end-nodes.

In embodiments of such ring topology networks 40 all of the transmitter systems Tx-1, Tx-2, . . . , Tx-n, can transmit their sparse (e.g., quantum) data/signals over the same main backbone optical fiber 43, while a single one of the plurality of receiver systems Rx-1, Rx-2, . . . , Rx-m, manages the transmission delays to guarantee that they don't overlap for each transmission direction i.e., both DR and DL (i.e., clockwise and counterclockwise, or “east and west” directions) transmission directions can be used. Since a single main backbone optical fiber 43 carries all for the communicated data/signals (e.g., quantum signals), the ordering of the transmitter systems Tx-1, Tx-2, . . . , Tx-n, is maintained as defined by the (channel or QKD) manager (25 or 29).

It is possible to neglect the chromatic dispersion in such embodiments if is the optical fiber 43 is not too long. In some embodiment the ring network system 40 is configured to precisely “lock” the wavelengths of all of the transmitter systems Tx-1, Tx-2, . . . , Tx-n, using feedback from the sparse data/signal detectors (12d e.g., single photon avalanche detectors—SPADs) of the receiver systems Rx-1, Rx-2, . . . , Rx-m, and photodiodes (44d in FIG. 4D) connected to narrowband filter (NBF 44) or interferometer units (48) of the receiver systems (Rx-m), for example. For instance, the receiver systems (Rx-m) transmitting to the other end-nodes the synchronization signals can use its photodiodes (44d) and/or NBFs (44) to determine occurrence of chromatic dispersion therein, and based thereon instruct (e.g., over the bidirectional communication channel C3) respective the transmitter systems Tx-i to adjust the wavelengths of the data/signals thereby transmitted over the unidirectional communication channel C1, and thereby overcome chromatic dispersion distortions.

Such ring network topologies 40 can be exploited to increase the resilience of MP2MP QKD implementations, and to provide the ability to share cryptographic keys between multiple transmitters and receiver systems on the ring 43, without a single point of failure i.e., many transmitter systems Tx-1, Tx-2, . . . , Tx-n, can communicate with many different receiver systems Rx-1, Rx-2, . . . , Rx-m, and many receiver systems Rx-1, Rx-2, . . . , Rx-m, can communicate with many different transmitter systems Tx-1, Tx-2, . . . , Tx-n.

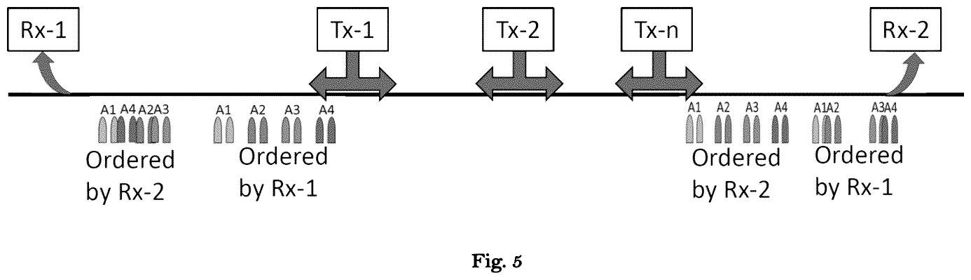

As shown in FIG. 5, if the same transmitter system Tx-i needs to send sparse (e.g., quantum) data/signal to two (or more) different receiver systems Rx-j, Rx-k, . . . and there is more than one fiber collecting the signal i.e., using a separate optical medium for each direction, the delay of each sparse data/signal pulse transmitted to each receiver system Rx-j, Rx-k, . . . needs to be set independently. For this purpose, the transmission can be divided into frames, one for each receiver system Rx-j, Rx-k, . . . , and each frame will have its own time delays managed by its respective receiver system Rx-j, Rx-k, . . . . As each receiver system Rx-j, Rx-k, . . . still gets all of the sparse (e.g., quantum) data/signals, each receiver system Rx-j, Rx-k, . . . can filter out or block e.g., by gating, the detector (12d) receiving the “messy” signals.

Here, multiple transmitter systems Tx-i and receiver systems Rx-j can communicate data/signals over the unidirectional communication channel C1 in a bidirectional way, without utilizing active optical switches, by letting each receiver system Rx-j to order a part of the data/signals from each transmitter system Tx-i. For example, with two transmitter systems, each transmitter system Tx-i can be configured to control the delay of every second data pulse.

For example, in a configuration wherein few transmitter systems Tx-1, . . . , Tx-n are transmitting both in the right and left directions simultaneously, the same signal (using a passive splitter for example) towards two (or more) receiver systems Rx-1 and Rx-2, each direction of propagation effectively acts as a separate optical fiber. Signals getting ordered by the receiver system Rx-1 on the left may not be ordered when getting to receiver system Rx-2 on the right, and vice versa.

To enable all of the transmitter systems Tx-i to transmit to both receiver systems Rx-1 and Rx-2, each receiver system controls the delays of every second optical data/signal pulse of every transmitter system Tx-i, and ignore the data controlled by the other receiver system Rx-j, which arrives in an un-ordered way.

In the ring network topology 40 multiple receiver systems (at least two, though there are advantages for use of a single receiver) can communicate with multiple transmitter systems. Possibly, between each receiver system there is at least one transmitter system, but nominally 3 or 4 transmitter systems can be alternatively present. In this configuration all of receiver systems receive the sparse (e.g., quantum) data/signals transmitted from all of the transmitter systems, such that each transmitter-receiver systems pair in the ring network 40 can carry out QKD to generate a respective cryptographic key.

In some embodiments the transmission in the ring network 40 is unidirectional at any given time. The “logical” configuration employed in such embodiments is trunk-based, which can be controllably terminated/blocked after any given receiver end-node system in the ring network 40 e.g., by software control. Accordingly, if the optical fibre of the ring 43 is cut, or is one of the receiver or transmitter systems therein fails, the direction of the communication can be reversed (e.g., from DR to DL, or vice versa) to maintain connectivity and communication between the systems.

The physical connection in the ring network 40 is a ring in order to allow reversal of communication direction. Logically, the interfaces RI/TI to the optical fiber 43 of the ring 40 shown in FIGS. 4B to 4D enable to implement a trunk configuration, allowing controllably terminating/blocking the communication over the unidirectional communication channel to at any end-node, so as to form a string of one or more transmitter and receiver systems, with a receiver system at the end.

Change of communication direction (e.g., implemented utilizing controllable shutters 42L,42M in the TI interfacing the transmitter systems to the ring network 40 to define the direction of transmission in the optical fibre 43) is desirable in the in the ring network 40 in case of a cut in the optical fiber 43, or equipment failure. The change of communication direction can also be desirable at set intervals to balance the losses and optimize overall performance (i.e., as the losses for any given transmitter-receiver pair are different, the highest loss in one direction entails lowest loss in the reverse direction). This way the “best” and “worst” link swap places and split the time as each at different loss levels.

For the termination, in order to cause a logical trunk/blockage, logically what is carried out in some embodiments is a termination/blockage of the data/signals over the unidirectional communication channel after a given receiver system in the ring network 40. Physically, this is implemented at the input to the following transmitter system, by blocking the optical signal there (e.g., by controllable shutters 42M in the TI interfacing the transmitter systems to the ring network 40, or by controllable splitters 41L in the RI interfacing the receiver systems to the ring network 40, to cause a “stub of fibre” from said receiver system to the following transmitter system, which in QKD implementation doesn't affect the QKD process).

In some embodiments hereof, the C1, C2 and C3, optical channels are split (not shown) to separate optical mediums (not shown e.g., optical fibers) at the input to each TI/RI setup, and only the optical medium of the unidirectional communication channel C1 is introduced into the TI/RI setup.

FIG. 4B schematically illustrates a possible setup TI for interfacing a transmitter system Tx-n for operation in the ring network 40. The interface TI utilizes “express lane input” for optically coupling to the optical fiber 43 of the ring 40 an (e.g., 99:1) optical coupler (e.g., 45L), a controllable optical shutter (e.g., 42M), and another (e.g., 99:1) optical coupler (e.g., 45R). Due to the bidirectional configuration of the ring network 40 in these embodiments, two respective optical couplers 45L,45R are required to split the signals communicated in each possible direction.

A main goal of this configuration is to minimise loss for optical light signals that propagates along the optical fiber 43 so it does not accumulate/circulate therein more than needed. Clearly, a series of 50:50 couplers will cause to high losses over very few end-nodes. In possible embodiments, the optical light signals entering the end-node from one direction (e.g., DL/west) mostly goes through to the other (e.g., DR/east) exit and continues along the ring optical fiber 43 along a “bypass route”47, which minimises losses along this path.

As illustrated, the 1% branch has no purpose at the input, as it is “open” due to the respective controllable shutter 42L,42M when it is in signal communication with the coupler 41 i.e., the combination of two controllable shutters 42L,42M and coupler 41 effectively form a controllable switch. The 1% branch at the output allows the locally transmitted optical signals of the transmitter system Tx-n to join the transmission. The 99% loss here is fixed and easily offset by calibration of a higher transmission power. When the direction of communication is reversed, the optical light signals from the EAST side propagate to the WEST side with minimal loss, and the transmitter system Tx-n can transmit to the WEST signal by accordingly setting the states of the controllable shutters 42L,42M. This design supports bidirectional transmission as desired in some cases, as exemplified in FIG. 5.

For example, if coupling ratio of the optical couplers 45L,45R is 99:1, the channel from previous transmitter or receiver system to the next transmitter or receiver system comprises a 1% attenuation due to the first coupler (e.g., 45L i.e., assuming no signal is present on the other/free leg of the optical coupler), the controllable shutter 42M, and a 1% attenuation of the other optical coupler (e.g., 45R). The signal transmitted by the transmitter system Tx-n passes the splitter 41 and the controllable shutter enabled for signal passage (42L or 42R) and then undergoes a 99% attenuation due to the optical coupler (45L or 45R), acting as a combiner. However, the transmission power of the transmitter system Tx-n can be controlled to offset the losses caused by the optical coupler (45L or 45R) enabled by the respective controllable shutter (42L or 42R). Optionally, the optical coupler 42L and 42R can be implemented with a variable optical attenuator (VOA) to precisely control the outgoing optical power.

The passage of signals from the splitter 41 to the optical couplers 45L,45R can be enabled or disabled by respective control signals cL, cR in accordance with the direction of the signal communication in the ring 40. For example, if the signal communication is in the DR direction, the control signal cL is set to disable signal passage through the controllable shutter 42L, and the control signal cR is set to enable signal passage through the controllable shutter 42R. Accordingly, when communication direction is reversed into the DL direction, signal passage through the controllable shutter 42L is enabled towards the optical coupler 45L for it to act as the combiner, and the signal passage through the controllable shutter 42R is disabled. Whenever loop truncation of the ring network 40 is required at the transmitter Tx-n, the control signal cM to the controllable shutter 42M connecting between the two optical couplers 45L,45R is accordingly set to disable passage of signals therethrough.

FIG. 4C schematically illustrates a possible setup RI for interfacing a receiver system Rx-m for operation in the ring network 40. Here, the receiver system Rx-m needs to have minimal losses on the through channel 43 in order to keep photon power above noise floor (dark counts) of other receiver systems in the ring 40. It is noted that the number of receiver systems attainable in possible embodiments can be limited by the dark counts. Thus, use of lower noise single photon detectors (12d), such as nanowire, can be considered when higher numbers of nodes are required.

One or more optical couplers are required to split the signal passing between the input of the receiver system Rx-m and the “through channel” 43 of the ring network 40, in order to provide continuous connection to subsequent receivers (while traversing the “express lane”/“bypass lane” of one or more transmitter and/or receiver systems along the ring network 40, each transmitter and/or receiver system contributes some nominal loss, which adds up). Due to the bidirectional configuration of such embodiments of the ring network 40, two such couplers 41L,41R are required for splitting the signals arriving from each of the communication directions DR, DL respectively.

In addition, each receiver end-node traversed will also add losses. In a possible approach, wherein two additional 50:50 optical couplers (such as 46L and 46R) are used, the loss of each receiver system Rx-i node crossed is >6 dB, in addition >3 dB input losses of each receiver, which adds up very fast to untenable losses.

A main goal of this design is thus to minimise loss on the optical light signals that propagates to subsequent Tx-j transmitter system nodes and to possible Rx-i receiver system nodes, and eventually to another Rx receive system node. A possible solution with minimal losses, use of optical switches or optical circulators 46L,46R can be incorporated in the through channel 43 to bypass the unused coupler 41R,41L, respectively.

As exemplified in FIG. 4D, exemplifying a qubit phase state detection configuration, in order to avoid additional 3 dB loss caused by the optical coupler at the inputs to the interferometer 48 of the receiver system Rx-m, a respective circulator 46L,46R can be coupled to the second leg of the interferometer 48, to thereby forms and leverage two equivalent inputs to the interferometer 48 with no additional losses. The interferometer 48 has two equivalent inputs (effectively symmetrical paths), and two asymmetric outputs optically coupled to (e.g., Farady) mirrors 49, where in P2P implementation one input port is unused. Thus, the unused port can be leveraged as a second equivalent input. In this configuration, qubits encoded onto time portions of transmitted light photons will destructively interfere at one side of the interferometer 48 and constructively interfere at the other side of the interferometer 48, and vice versa, thereby allowing detection a first qubit state in a first detector DetL connected to one side of the interferometer 48 via circulator 46L, the and a second qubit state in a second detector DetR connected to the other side of the interferometer 48 via circulator 46R.

Given the rising loss along the optical fiber line 43 of the ring 40, the network can be managed with fixed time slots, where the “breakpoint” defining the trunk (i.e., set by the control signal cM) is consecutively moved from one receiver system to the next receiver system in the ring 40, so that each receiver system has some time with each level of attenuation (which affects key rate). Further balance can be achieved by reversal of the direction of each sequence. This “breakpoint”, that defines the order of the trunk within the physical ring 40 is implemented by the controllable shutter 42M in the express channel of the interfacing configuration TI of the transmitter system located after the receiver system Rx-m. This defines a beginning and an end to the “trunk” with a few transmitter systems, thereafter a receiver system, and thereafter one or more other transmitters, and thereafter another receiver system, and so on, so as to prevent the signals from the first transmitter system from reaching the same receiver system twice over the ring 40.

In possible embodiments optimisation of the coupling ratio of the couplers 41L,41R used in the receivers interfaces RI may be required to optimise loss to last receiver system in the chain along the truncated ring 40. In the event there are three or more receiver systems in the ring network 40, the accumulated losses might near the dark count level of the last receiver system in the chain, such that QKD key generation cannot be accomplished. Imbalanced (non 50:50) coupler 41L,41R can be used in some embodiments in order to lower the “through loss” of each receiver system, at the expense of lower signal in the receiving receiver system, thereby increasing the total loss in the links comprising less segments, but lower total loss in the links with the most segments. This gives a better balance of loss on different chains, and keeps all received signal levels above the dark count levels.

In some embodiment optical variable splitters are used in the transmitters'and/or the receivers'interfaces TI, RI, as may be required in multiple receiver systems configuration, or central transmitter configuration, so as to allow adjusting of split ratio for optimal balance of loss over different Tx-Rx chains.

In possible embodiments a calibration procedure is utilized for synchronizing the start time of sparse (e.g., quantum) data/signals transmissions from the different transmitter systems Tx-1, Tx-2, . . . , Tx-n. In such calibration procedures, the central/master system (a receiver system Rx-j in possible embodiments hereof) can be configured to continuously transmit an internal counter (14c) value or time-stamp thereof thereof after a predefined period of time or bits count of its clock (12k) e.g., if a PRBS clock (12b) is used either a pre-set number of PRBS cycles, or a known location within the PRBS cycle, or the index of the PRBS cycle, can be used as the internal counter value. For example, the internal counter value can be transmitted after the longest “0” sequence of the PRBS, which is a unique pattern repeated only once during the PRBS sequence.

Upon receipt of the internal counter value each transmitter system Tx-1, Tx-2, . . . , Tx-n, starts its sparse data/signals (e.g., quantum) transmission over the unidirectional communication channel (C1), and transmits to the central/master system (e.g., Rx-j) the internal counter value it received over the classical communication channel (C3) e.g., in QKD implementations, if the receiver is carrying out the correlation between the sparse quantum data/signals thereby received and the quantum data actually transmitted by the transmitter system (e.g., transmitted to the receiver Rx-j by the receiver over the IP channel/management channel C3). The back-to-back delay ΔT_{b2b} (i.e., the internal delay of the node, with a short optical fiber connecting the systems) between the transmission of the internal counter value by the receiver Rx-j and the reception of the sparse (e.g., quantum) data/signal from receiver Rx-j over the unidirectional communication channel (C1), is constant per system design, because high-speed electronic components are essentially utilized.

If software code execution is involved in the process, the response time of the software code can be calibrated as well. As the delay of optical fiber and passive optical components is typically about 5 μsec/km, the transmitter and receiver systems will need to correlate the sparse (e.g., quantum) data/signals received by the receiver Rx-j with the actually transmitted (e.g., quantum) data/signals (e.g., as provided by the transmitter over the classical communication channel C3), over a small amount of data that corresponds to the estimated length of the optical fiber connecting between the transmitter and the receiver Rx-j. Based on the correlation between the received sparse data/signals and the actually transmitted data/signals the system can determine the total round-trip optical fiber delay ΔTᵣₜ.

This calibration procedure can substantially reduce the computation power and memory (11m, 12m) requirements of the processors (11p,12p) of the transmitters and of the receivers, and allows substantial power saving and cost reduction. If the back-to-back delay ΔT_{b2b} cannot be calibrated, or if the optical fiber length is unknown, the correlation can be done once with a lengthier calculation at the transmitter or the receiver, or in another an external server, for correlating between the sparse (e.g., quantum) data/signals received by the receiver with the actually transmitted data/signals. As the result of this calculation is constant for each transmitter-receiver pair, the correlation can be repeatedly calculated over a small data set adjusted in accordance with correlation results of the lengthy calculation, if the transmission is re-initialized for any reason.

Tracking the value of the total round-trip optical fiber delay ΔTᵣₜ can give meaningful information about the infrastructure used in the system, such as the round-trip optical fiber length, and an indication that changes in the length of optical fiber were made. In addition, together with the optical loss estimation from the synchronization channel (C2) and the sparse (e.g., quantum) data/signals channel (C1), an estimation of the infrastructure state can be determined, and attenuation changes can be monitored. This information and determinations are important for QKD implementations, because QKD systems acts like a sensor of the infrastructure, as they attempt to recognize changes and attacks.

It should also be understood that throughout this disclosure, where a process or method is shown or described, the steps of the method may be performed in any order or simultaneously, unless it is clear from the context that one step depends on another being performed first. It is also noted that terms such as first, second, . . . etc. may be used to refer to specific elements disclosed herein without limiting, but rather to distinguish between the disclosed elements.

Those of skill in the art would appreciate that items such as the various illustrative blocks, modules, elements, components, methods, operations, steps, and algorithms described herein may be implemented as hardware or a combination of hardware and computer software. To illustrate the interchangeability of hardware and software, items such as the various illustrative blocks, modules, elements, components, methods, operations, steps, and algorithms have been described generally in terms of their functionality. Whether such functionality is implemented as hardware or software depends upon the particular application and design constraints imposed on the overall system. Skilled artisans may implement the described functionality in varying ways for each particular application.

Features of the disclosed embodiments can be implemented primarily in hardware using, for example, hardware components such as application specific integrated circuits (ASICs) or field-programmable gated arrays (FPGAs). Implementation of the hardware state machine so as to perform the functions described herein will be apparent to persons skilled in the relevant art(s).

As described hereinabove and shown in the associated figures, the presently disclosed subject matter provides P2MP and MP2MP network configurations, and related methods usable for QKD implementations. While particular embodiments of the presently disclosed subject matter have been described, it will be understood, however, that the presently disclosed subject matter is not limited thereto, since modifications may be made by those skilled in the art, particularly in light of the foregoing teachings. As will be appreciated by the skilled person, the presently disclosed subject matter can be carried out in a great variety of ways, employing more than one technique from those described above, all without exceeding the scope of the claims.

1. A communication network comprising at least one receiver system optically coupled to a plurality of transmitter systems for transmission of synchronization signals generated by the at least one receiver system to the plurality of transmitter systems over a unidirectional synchronization channel, said at least one receiver system configured to embed into the synchronization signals thereby generated additional data indicative of an internal time count thereof for synchronization of transmission of data/signals from each one of the plurality of transmitter systems to said at least one receiver system over a sparse data/signals unidirectional communication channel.

2. The communication network of claim 1 further comprising a bidirectional communication channel configured for classical data exchange between the at least one receiver system and the plurality of transmitter systems, for thereby carrying out QKD key generation procedures between the at least one receiver system and the plurality of transmitter systems based on the data/signals transmitted over the sparse data/signals communication channel.

3. The communication network of claim 1 wherein the synchronization signal comprises a PRBS.

4. The communication network of claim 3 wherein the additional data comprises, a time-tag indicative of a number of PRBS cycles of the synchronization signal, and/or an identifier of one of the plurality of transmitter systems and time-interval(s) during which said transmitter system is permitted to transmit data/signals over the sparce data/signals unidirectional communication channel.

5. The communication network of claim 1 configured for one of the following: determine by each one of the plurality of transmitter systems a time delay between transmission and reception of data/signal thereby transmitted over said sparse data/signals unidirectional communication channel using a portion of the data/signals, said portion selected based on the additional data embedded in the synchronization signals, determine by each one of the plurality of transmitter systems a time delay between transmission and reception of data/signal thereby transmitted over said sparse data/signals unidirectional communication channel based on a correlation between selected portion of the data/signals and a pattern received by the at least one receiver system responsive to the data/signals thereby transmitted over the sparse data/signals unidirectional communication channel; transmit by each one of the plurality of transmitter systems the selected portion of the data/signals to the at least one receiver system for thereby carrying out the correlation and accordingly determining the delay time.

6. (canceled)

7. The communication network of claim 1 wherein the at least one receiver system is configured to embed the additional data into the synchronization signals by flipping a number of bits thereof.

8. (canceled)

9. The communication network of claim 1 configured to achieve the optical coupling over one or more optical fibers and/or free space, and to realize the different channels therein by respective different wavelengths or wavelength ranges.

10. The communication network of claim 1 comprising a single receiver system and one or more passive splitters optically coupling between said single receiver system and the plurality of transmitter systems and configured to direct the data/signals transmitted from all of said plurality of transmitter systems over the sparse data/signals unidirectional communication channel for receipt by a single detector of said single receiver system.

11. The communication network of claim 1 comprising a plurality of receiver systems each of which optically coupled to a respective plurality of transmitter systems by one or more passive splitters and backbone data/signal line configured to realize all of the communication channels between said plurality of receiver systems and said plurality of transmitter systems.

12. The communication network of claim 11 configured to assign to each one of the plurality of receiver systems a time-window during which it is permitted to communicate data/signals with all of the transmitter systems in said communication network, and/or to assign to each ono of the plurality of receive systems a plurality of non-overlapping sub-time-windows, within its window, each one of said plurality of non-overlapping sub-time-windows defining a time-interval during which transmitter systems of the respective plurality of transmitter systems are permitted to communicate data/signals with the receiver system to which said plurality of non-overlapping sub-time-windows are assigned.

13. (canceled)

14. The communication network of claim 1 configured as a ring network comprising a transmitter interface unit for coupling each one of the plurality of transmitter system to said ring network, and a receiver interfacing unit for coupling each one of the receiver systems to said ring network, each of said interfacing units configured for said transmitter and receiver systems to receive the communication over the communication channels, and transmit data/signal thereover, without interrupting said communication.

15. The communication network of claim 14 wherein the interfacing units are configured to controllably switch direction of signal communication along said ring network, and/or to controllably block the communication over said ring network at a selected one of the plurality of transmitter systems and permit communication in a determined direction oriented respective to said selected one of the plurality of transmitter system.

16. (canceled)

17. The communication network of claim 14 configured to permit all of the receiver system to receive the communication from all of the transmitter systems in said communication network, and/or invert the determined direction of communication in thein so as to improve the commination to at least one of the received systems.

18. (canceled)

19. The communication network of claim 14 to-wherein each transmitter interface unit comprises two imbalanced couplers configured for respectively coupling the communication to the transmitter system to the ring network from east and west sides thereof.

20. The communication network of claim 19 comprising: a shutter configured to controllably block the communication through the bypass communication line; and/or a bypass communication line connecting a pair of output ports of the imbalanced couplers, and splitter configure to optically couple another pair of output ports of said imbalanced couplers to the transmitter system.

21. (canceled)

22. The communication network of claim 20 comprising a west side shutter configured to controllably block west side communication to the splitter, and an east side shutter configured to controllably block east side communication to said splitter.

23. The communication network of claim 14 wherein each receiver interface unit comprises a west circulator configured to receive west side communication from the ring network via a first port thereof, an east circulator configured to receive east side communication from the ring network via a first port thereof, a west splitter optically coupling between to a second port of said west circulator, a third port of said east circulator, and the receiver system and between, and an east splitter optically coupling between to a second port of said east circulator, a third port of said west circulator, and said receiver system.

24. The communication system of claim 23 wherein the receiver system comprises a detection unit comprising a west circulator optically coupled to the west splitter via a first port thereof, an east circulator optically coupled to the east splitter via a first port thereof, an imbalanced interferometer optically coupled second ports of said circulators via its inputs ports, two detectors respectively optically coupled to third ports of said circulators, and two mirrors respectively coupled to output ports of said imbalanced interferometer.

25. The communication network of claim 1 wherein at least one of the receiver systems is configured to measure the data/signals transmitted over the sparse data/signals unidirectional communication channel and based thereon transmit instructions to at least one of the transmitter systems to adjust a wavelength of its transmissions over said sparse data/signals unidirectional communication channel.

26. The communication network of claim 1 configured to determine length and/or changes therein based at least on one of a back-to-back and round-trip delay times.
